(19) United States
(12) Patent Application Publication
(10) Pub. No.: US 2015/0309474 A1
(43) Pub. Date: Oct. 29, 2015

(54) PROCESS FOR MANUFACTURING A STRENGTHENED TIMEPIECE COMPONENT AND CORRESPONDING TIMEPIECE COMPONENT AND TIMEPIECE

(71) Applicant: ROLEX SA, Geneva (CH)

(72) Inventors: Richard Bossart, Attalens (CH); Denis Favez, Grand-Saconnex (CH)

(73) Assignee: ROLEX SA, Geneva (CH)

(21) Appl. No.: 14/695,697

(22) Filed: Apr. 24, 2015

(30) Foreign Application Priority Data
Apr. 25, 2014 (EP) 14165968.0

(51) Int. Cl. G04B 1/14; G04B 15/14; G04B 13/00; G04B 31/004; G04B 31/06

(52) U.S. Cl. CPC G04B 1/145; G04B 31/004; G04B 31/06; G04B 13/00; G04B 15/14

(57) ABSTRACT

The manufacturing process produces a part (10), from a micromachinable material, the part (10) forming a blank of the timepiece component and comprising at least one surface having an initial roughness. It comprises a step of mechanical strengthening treatment of the part in an etching fluid intended to decrease the roughness of said surface. For example, a substrate of said micromachinable material is provided; the substrate is at least partially covered with a protective coating containing at least one aperture; the substrate is etched through the aperture in the protective coating and an etched surface is thus obtained; the mechanical strengthening treatment is applied to said etched surface through the aperture in the protective coating; and then the protective coating is removed. The etching fluid may be a plasma or a liquid chemical etchant.

The invention relates to a process for manufacturing a timepiece component from a micromachinable material, silicon for example.

Silicon is a material that has many advantages as regards the manufacture of timepiece components. On the one hand it allows a large number of small parts to be manufactured simultaneously with micron-sized precision. On the other hand it has a low density and a diamagnetic character. However, this material has one drawback: its plastic deformation region is small or non-existent, thereby making it a relatively fragile material. A mechanical strain or a shock may lead to the component cracking. Handling timepiece components made of silicon, especially during their manufacture and their mounting, therefore turns out to be a particularly delicate task.

The techniques used to cut timepiece components from silicon substrates, generally deep etching techniques, deep reactive ion etching (DRIE) for example, accentuate the fragility of these silicon timepiece components. One particularity of this type of etching is that it forms apertures having slightly striated sidewalls that contain, on their surface, planarity defects taking the form of wavelets or “scallops” as they are known in the art. As a result, the etched sidewalls have a certain roughness, which decreases the mechanical strength of the component. Furthermore, planarity defects may act as crack initiators, especially under mechanical strains, and lead to the component breaking.

To improve the mechanical properties of timepiece components made of silicon, a number of approaches have already been proposed.

A first approach, described in document EP 2 277 822, consists in forming a silicon oxide layer by thermal oxidation of the silicon at a temperature comprised between 900° C. and 1200° C. The oxide layer formed results from conversion of the silicon on the surface of the component into silicon oxide. The silicon oxide is then dissolved. The formation of the silicon oxide layer and its dissolution allows the surface portion of the silicon, which potentially comprises defects and/or crack initiators, to be removed.

A second approach, described in document CH 703 445, consists in applying, to the silicon part (i.e. to the timepiece component blank) obtained after etching, an annealing treatment at a temperature of about 1000° C. in a reducing atmosphere. According to this document, the annealing treatment causes silicon atoms to migrate, these atoms migrating from convex corners (such as the tips of the scallops and edges) and accumulating in concave corners, thereby decreasing the roughness of the sidewalls and rounding edges.

The present invention proposes an alternative to the approaches proposed beforehand.

For this purpose, the invention relates to a process for manufacturing a timepiece component, in which a part forming a blank of the timepiece component is produced from a micromachinable material, said part comprising at least one surface having an initial roughness, wherein it comprises a step of mechanically strengthening the part in an etching fluid intended to decrease the roughness of said surface.

The term “fluid” must here be understood in the physical sense of the term. In physics, “fluids” form a subset of the phases of matter, which includes liquids, gases and plasmas (and to a certain extent certain plastic solids).

Advantageously, the step of mechanically strengthening the part in an etching fluid is of isotropic type.

The process of the invention has the advantage of not requiring high temperatures to be used.

In one particular embodiment, the process comprises the steps of:
providing a substrate of said micromachinable material;
at least partially covering the substrate with a protective coating containing at least one aperture;
etching the substrate through the aperture in the protective coating and thus obtaining an etched surface;
applying the mechanical strengthening treatment to said etched surface through the aperture in the protective coating; and
then removing the protective coating.

The two approaches of the prior art aim to decrease surface defects on the sidewalls of the silicon part but are accompanied by potentially undesirable effects: the dimensions of the part are substantially modified by the first approach and edges are rounded by the second approach.

According to the invention, the treatment with an etching fluid may be carried out with the protective coating still present on the part. By virtue of this, only the etched surfaces are selectively treated and smoothed, the surfaces covered by the protective coating remaining unetched. This selective mechanical strengthening treatment is simple to implement as no additional steps are required, the protective coating already produced for the sake of the etching being reused. Thus, the surfaces protected for the sake of the etching (for example the top and bottom surfaces of a silicon wafer, which may be polished and have a polished mirror finish) are not etched by the treatment and therefore do not risk being damaged by the latter. Furthermore, edges are not rounded by the treatment according to the invention.

The mechanical strengthening treatment may be a plasma treatment or a treatment in a liquid chemical etchant. The plasma may be formed from a halogen-containing gas and especially a fluorine- or chlorine-containing gas. In this case, advantageously, the component blank is electrically biased during the plasma treatment. By virtue of this, the plasma etching is concentrated on the points where the electric field is highest, in other words on tips and protuberances protruding from the surface of the part. This has the effect of smoothing the roughness of the surface.

Advantageously, the process comprises all or some of the following additional features:
the plasma is formed from a halogen-containing gas and especially a fluorine- or chlorine-containing gas;
the part is electrically biased during the plasma treatment;
the liquid chemical etchant comprises an acid or a base, especially potassium hydroxide or a mixture of hydrofluoric, nitric and/or acetic acids;
an aperture is etched through the substrate and the etching treatment is applied to the sidewall of said aperture in the substrate;
the substrate is etched by deep etching, especially by deep reactive ion etching (DRIE);
the protective coating is made of photoresist or of silicon oxide; and/or
the component blank is produced using a LIGA technique or using a laser cutting technique.

The invention also relates to a timepiece component obtained by the manufacturing process defined above, and to a timepiece component incorporating this timepiece component.

The invention will be better understood by way of the following description of one particular embodiment of the process for manufacturing a timepiece component according to the invention, and of variant embodiments thereof, given with reference to the appended drawings in which:

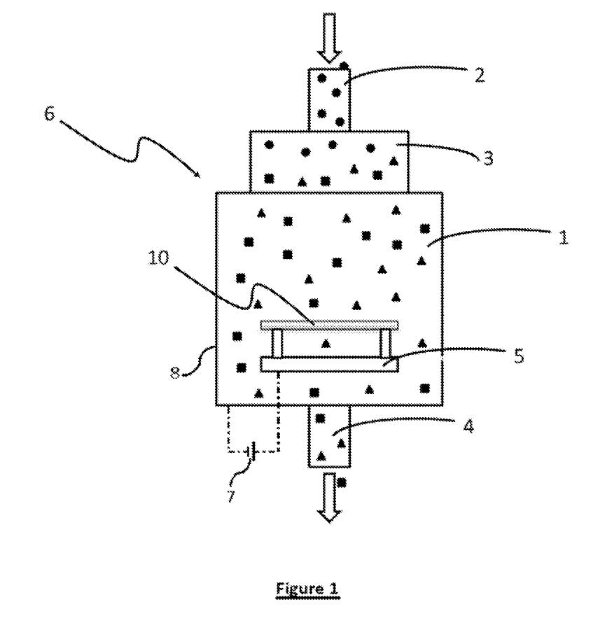

FIG. 1 shows a tool for treating a timepiece component, for implementing the process of the invention, according to one particular embodiment; and

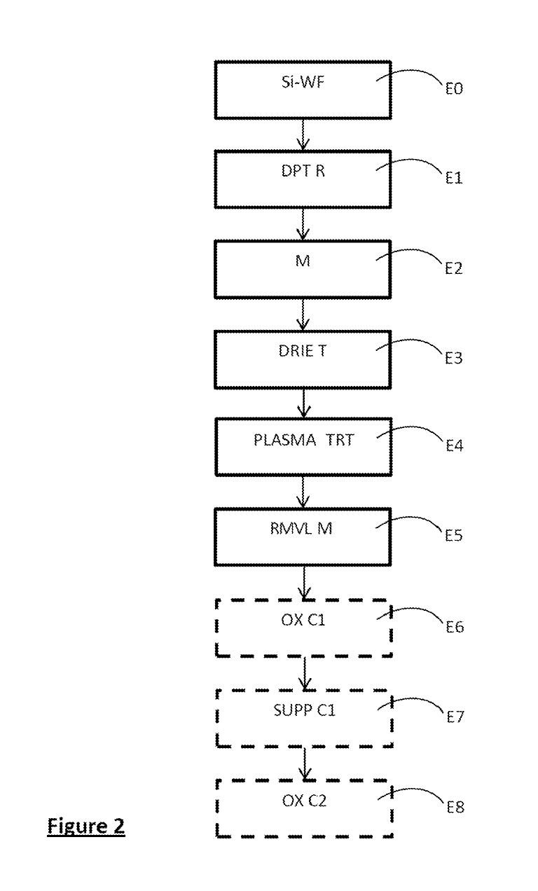

FIG. 2 shows a flow chart of the steps of the process.

The process of the invention allows timepiece components having strengthened mechanical properties to be manufactured from a micromachinable material. By way of illustrative and nonlimiting example, these components may be toothed wheels, escapement wheels, hands, impulse pins, pallets or springs, especially return springs or balance (spiral) springs.

FIG. 2 shows a flow chart of various steps of the process for manufacturing a timepiece component, according to a first embodiment of the invention.

According to this first embodiment, the process comprises an initial step E0 consisting in providing a substrate made of a micromachinable material. The substrate is for example a silicon wafer, denoted Si—WF. As a variant, a substrate made of quartz, diamond or any other micromachinable material suitable for manufacturing a timepiece component could be used instead.

In a following step E1, the entirety of the surface of the wafer Si—WF, and especially its two (front and back) sides, is here covered with a protective coating. As a variant, only one of the two sides could be covered with a protective coating, the front side for example. The protective coating R is here made of photoresist on the front side.

The process then continues with a step E2 of forming a resist pattern in the protective coating R. The resist pattern is produced by creating apertures through the layer of photoresist R. The protective coating R containing the apertures forms a protective mask M. The apertures may be produced by exposing the resist through a mask then developing the resist (i.e. dissolving, using a developer, exposed or unexposed portions of the resist depending on whether the resist is positive or negative). As a variant, the resist may be removed using a laser ablation technique or by applying an electron beam followed by development.

Step E2 is followed by a step E3 of etching the silicon wafer through the protective mask M, here by deep reactive ion etching (DRIE). In the etching step E3, one or more apertures or holes T are etched in the silicon Si—WF plumb with the one or more apertures in the mask M. The etched holes T preferably extend right through the wafer Si—WF. However, one or more blind holes could be etched.

The DRIE etching technique is directional. It works by applying alternated cycles of plasma etching, to etch the bottom of each hole T, and of depositing a protective layer on the newly etched sidewalls. By virtue of this, the etching of the silicon is directed so as to produce a hole T that extends only plumb with each aperture, through the protective mask M without extending under the mask. This alternation of plasma etching and deposition of a protective layer on the sidewalls creates on the surface of the latter planarity defects taking the form of what are referred to as “scallops”, that make the surface rough.

The etching step E3 is followed by a step E4 of mechanically strengthening the silicon part obtained after the etching, this part forming a timepiece component blank. The mechanical strengthening treatment consists in a treatment in which the surfaces etched in the preceding step E3, in the present case the sidewalls of the holes produced by etching, are treated (particularly re-etched) in a fluid.

In the embodiment described here, the treatment used on the sidewalls is a plasma treatment. The plasma may be formed from a halogen-containing gas such as a fluorine-containing gas (NF₃, CF₄ or SF₆ for example) or a chlorine-containing gas. It may also comprise an unreactive diluent gas such as helium or argon.

Furthermore, during the plasma treatment, the silicon substrate is here electrically biased. Biasing the silicon allows the plasma etching to be concentrated on points where the electric field is stronger, in other words on tips and protuberances protruding from the surface of the part.

The conditions and parameters of the plasma treatment, the plasma for example being formed from a gas containing SF₆, may be as follows:
gas containing between 10% and 85% by volume SF₆;
gas flow having a flow rate comprised between 1 and 200 sccm;
gas pressure in the chamber comprised between 0.1 Pa and 5 Pa;
plasma source power comprised between 500 W and 3000 W;
bias of the substrate comprised between −10 V and −40 V;
substrate temperature comprised between 20° C. and 120° C.; and
treatment time comprised between 30 s and 300 s.

The plasma treatment has the effect of smoothing the sidewalls of the etched holes and therefore of decreasing their roughness. The bias of the substrate further reinforces the smoothing effect of the plasma treatment. The planarity defects of the sidewalls of the etched holes thus being largely decreased, or even removed, an improvement is obtained in the mechanical properties of the silicon part, and especially of its mechanical strength. Furthermore, the tribological friction properties of the treated surfaces are improved.

As a remark, the implemented plasma treatment forms an isotropic etching. Such feature involves an equal attack (etching) speed, independent of the orientation of the planes of the surface to smooth. In presence of components without flat surface, this allows to reach an homogeneous and satisfactory result, regardless to the duration of the treatment.

FIG. 1 shows a treatment tool for carrying out the smoothing plasma treatment. The tool 6 comprises a reaction chamber 1 that is bounded by an enclosure 8. The chamber 1 is connected to an inlet of a precursor gas 2, represented by the circles, via an inductively coupled plasma (ICP) chamber 3 intended to produce ions and radicals, represented by triangles and squares, respectively, from the precursor gas. The chamber 1 also comprises a pumping outlet 4, through which the ions and radicals are evacuated from the chamber 1. A holder 5 intended to hold the part to be treated is placed in the chamber 1. The holder 5 is connected to an electrical voltage generator 7, also connected to the enclosure 8, as shown in FIG. 1. The generator 7 thus allows the part to be treated placed on the holder 5 to be biased.

The mechanical strengthening treatment is carried out with the protective mask M still present on the silicon substrate. By virtue of this, the treatment is selective, i.e. it is applied only to surfaces not covered by the resist. Thus, the sidewalls of the etched apertures are selectively smoothed. The surfaces covered by the resist remain protected and do not risk being damaged by the plasma treatment, which is potentially liable to impair their finish substantially. This is especially the case in the case where the surfaces have a polished mirror finish. Such surfaces would be slightly damaged by the mechanically strengthening plasma treatment. The protective resist coating allows these surfaces to be kept perfectly intact. Furthermore, the selective character of the treatment makes it possible not to create a chamfer or rounding of the edge between the front side of the part and the sidewalls of the apertures through the silicon.

Another advantage of the process is that it allows, after the smoothing and mechanical strengthening treatment step E4, additional layers to be deposited selectively only on the sidewalls, without it being necessary to carry out a selective additional step of masking the front and/or back surfaces of the part. In addition, the adhesion of such a deposit is strengthened by virtue of the decrease in the roughness obtained at the end of step E4.

The process continues with a step E5 of removing the mask M, in the conventional way, by dissolving the resist.

After the resist has been removed, the process may optionally comprise a double thermal oxidation, carried out via steps E6 to E8. In step E6, a first layer C1 of silicon oxide SiO₂ is formed by thermally oxidizing the surface of the silicon, the entire surface of the part obtained after the step E5 of removing the resist being oxidized in this way. In step E7, the oxidation layer C1 is removed by chemical etching, for example using a hydrofluoric acid solution. Next, in step E8, a second layer C2 of silicon oxide is formed by thermally oxidizing the surface of the silicon, the entire surface of the part such as obtained from the preceding step E7 being oxidized in this way. The formation of the first oxide layer C1 then its removal makes it possible to remove surface defects initially present in the portion of the silicon that is converted into silicon oxide in step E6. The formation of the second oxide layer C2 makes it possible to remove even more surface defects. Specifically, the conversion of the silicon surface into silicon oxide allows, if needs be, superficial micro-apertures to be made to disappear and microcracks to be blocked.

Instead of a double oxidation, only steps E6 and E7 of oxidation and removal of the oxide layer could be carried out, or even only the oxidation step E6.

Instead of the plasma, the mechanically strengthening step E4 may use a fluid, especially liquid, chemical etchant comprising a base or an acid. Advantageously, fluid with isotropic action like mixture comprising a base of hydrofluoric (“HNA”) are preferred, so that to avoid the anistropic effect of treatment with other fluids like for example potassium hydroxide (“KOH”) or tetra methyl ammonium hydroxide (“TMAH”).

Using an anisotropic strengthening treatment, there is a risk to microscopically modify the component geometry, as defined by the protective coating, due to the different attack speed between the different planes of the silicon. Initially circular microetching could become rectangular. Such anisotropic treatment remains a second embodiment of the invention.

In step E4, the part to be treated obtained in step E3 may be submerged in a bath containing one of these etchant fluids for a preset length of time.

These fluid chemical etchants allow the bare silicon surfaces, namely the sidewalls of the etched apertures, to be etched directly and these bare surfaces to be smoothed by chemical etching. The nature of the protective coating R is adapted to the liquid chemical etchant used. In any case, the thickness of the coating R and the length of time spent submerged in the bath of liquid chemical etchant are adapted so that the protective coating effectively protects the covered surfaces throughout the treatment in the bath of liquid chemical etchant.

In the above description, the step E4 of mechanically strengthening the silicon part is carried out before the protective coating is removed. As a variant, this step could be carried out after the resist has been removed, or even after the one or more oxidation steps (E6 to E8).

The protective coating could be made of silicon oxide SiO₂ instead of photoresist.

According to the invention, the mechanical strengthening treatment (step E4) could be applied to parts (timepiece components or timepiece component blanks) produced using a technique other than etching, for example using a LIGA technique or a laser cutting technique. In the case of a part manufactured by LIGA from a resist mould, the plasma etching (or the etching in a fluid chemical etchant) would allow those surfaces of the part which made contact with the resist mould to be smoothed. In the case of a part manufactured by laser cutting, the plasma etching (or the etching in a fluid chemical etchant) would allow the surfaces cut by laser to be smoothed.

The invention also relates to a timepiece component fabricated using the fabrication process described above, and to a timepiece incorporating this timepiece component.

1. A process for manufacturing a timepiece component, comprising:
producing a part forming a blank of the timepiece component from a micromachinable material, said part comprising at least one surface having an initial roughness, and
performing a mechanical strengthening treatment of the part by an etching fluid intended to decrease the roughness of said surface.

2. The process as claimed in claim 1, wherein the mechanical strengthening treatment of the part by an etching fluid is of isotropic type.

3. The process as claimed in claim 1, comprising:
providing a substrate of said micromachinable material;
at least partially covering the substrate with a protective coating containing at least one aperture;
etching the substrate through the aperture in the protective coating and thus obtaining an etched surface;
applying the mechanical strengthening treatment to said etched surface through the aperture in the protective coating; and
then removing the protective coating.

4. The process as claimed claim 1, wherein the mechanical strengthening treatment is a plasma treatment or a treatment with a liquid chemical etchant.

5. The process as claimed in claim 4, wherein the mechanically strengthening treatment is a plasma treatment, and wherein the plasma is formed from a halogen-containing gas.

6. The process as claimed in claim 4, wherein the mechanically strengthening treatment is a plasma treatment, and wherein the part is electrically biased during the plasma treatment.

7. The process as claimed in claim 4, wherein the mechanically strengthening treatment is a treatment with a liquid chemical etchant, and wherein the liquid chemical etchant comprises an acid or a base.

8. The process as claimed in claim 3, wherein an aperture is etched through the substrate and the etching treatment is applied to a sidewall of said aperture in the substrate.

9. The process as claimed in claim 3, wherein the substrate is etched by deep etching, especially by deep reactive ion etching (DRIE).

10. The process as claimed in claim 3, wherein the protective coating is made of photoresist or of silicon oxide.

11. The process as claimed in claim 1, wherein the component blank is produced using a LIGA technique or using a laser cutting technique.

12. The process as claimed in claim 1, wherein the micromachinable material is selected from the group consisting of silicon, diamond and quartz.

13. The process as claimed in claim 1, wherein the timepiece component is selected from the group consisting of a toothed wheel, an escapement wheel, a hand, an impulse pin, a pallet and a spring.

14. A timepiece component obtained by the manufacturing process as claimed in claim 1.

15. A timepiece comprising a timepiece component as claimed in claim 14.

16. The process as claimed in claim 5, wherein the plasma is formed from a fluorine- or chlorine-containing gas.

17. The process as claimed in claim 7, wherein the liquid chemical etchant comprises potassium hydroxide or a mixture of hydrofluoric, nitric and/or acetic acids.

18. The process as claimed in claim 13, wherein the timepiece component is a return spring or a balance spring.

19. The process as claimed in claim 3, wherein the mechanical strengthening treatment of the part by an etching fluid is of isotropic type.

20. The process as claimed in claim 3, wherein the mechanical strengthening treatment is a plasma treatment or a treatment with a liquid chemical etchant.
